(19) United States
(12) Patent Application Publication
(10) Pub. No.: US 2015/0007702 A1
(43) Pub. Date: Jan. 8, 2015

(54) Parallelogram Saw

(71) Applicant: Robert Benjamin Joiner, Milledgeville, GA (US)

(72) Inventor: Robert Benjamin Joiner, Milledgeville, GA (US)

(21) Appl. No.: 13/937,194

(22) Filed: Jul. 8, 2013

(51) Int. Cl. B27B 27/08; B27B 5/24; B27B 5/18

(52) U.S. Cl. CPC B27B 27/08; B27B 5/181; B27B 5/243
USPC 83/13; 83/471.2; 83/477.2; 29/401.1

(57) ABSTRACT

The present invention includes a saw table, which can be converted into a parallelogram position. Converting the saw table into a parallelogram position allows for the angle of the blade relative to the fence and work-piece to change with ease. This invention also comprises an adjustable blade guard, which facilitates various cuts on or through work-pieces with minimal efforts.

### CROSS-REFERENCE TO RELATED APPLICATIONS

This application is a non-provisional application claiming priority to U.S. provisional patent application Ser. No. 61/690,978 filed Jul. 10, 2012, entitled Parallelogram Saw, the contents of which are hereby incorporated by reference as if recited in full herein.

### FIELD OF INVENTION

The field of this invention relates to sawing apparatuses. More specifically, the field of this invention relates to a customizable combination saw table and miter saw apparatus which allows for cutting materials at varied angles.

### BACKGROUND OF INVENTION

Construction workers usually need several pieces of equipment to perform their jobs accurately and efficiently. Furthermore, it is not uncommon for a construction worker to need multiple saws such as a miter saw for making accurate angled cuts across work-pieces and a saw table for performing straight cuts across work-pieces. Transporting and using multiple saws is inefficient because they take up additional space, create more pieces to keep up with, and increase purchasing and maintenance costs. For instance, a chop-style miter saw and the table which it is attached to must be heavy duty to support the saw. Current combination saw tools such as the flip over saw, must have a table thin enough for the blade to protrude through; however, the hefty size of miter saw limits the capacity of the saw table functionality.

Although the prior art contains various examples of convertible saws which may be used as a miter saw or as a saw table, the prior art fails to teach a method for pivoting the table about an axis which will allow for a saw table conversion to a miter saw, with a pivoting fence, with ease. Therefore, it is desirable to have a combination saw which can perform several functions such as those of a saw table, miter saw, and fence alignment using simple conversion means.

### SUMMARY OF INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

To resolve the problems mentioned above, an object of the present invention is to provide a saw table which can easily cross-cut, miter, or rip work-pieces without the need for extraneous extension structures. Another object of this invention is to provide a saw table that can quickly be converted from one type of sawing operation to another and is safe to operate.

Accordingly, a saw table is provided comprising a circular power driven saw mounted on a blade guard attached to a track assembly in a manner to allow longitudinal movement of the blade guard on the track assembly. The track assembly is attached to the frame structure to allow for movement of the blade guard. A miter-rip fence is variably positionable on a tabletop attached to the frame structure, the fence having attaching means allowing fixed attachment of the fence to the tabletop in a desired position, and the tabletop having a channel to allow the blade to extend through the table and to guide the blade during longitudinal movement. Rotators provide a means for pivoting the saw table about an axis to facilitate saw table position changes.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a perspective view of the saw table.

FIG. 2 is a top view of the saw table.

FIG. 3 is side cut-away view of the saw table showing the adjustable blade and track.

FIG. 4 is a top view of the saw table after it has been pivoted to its parallelogram position.

FIG. 5 is a perspective view of the saw table pivoted to its parallelogram position.

### DETAILED DESCRIPTION

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

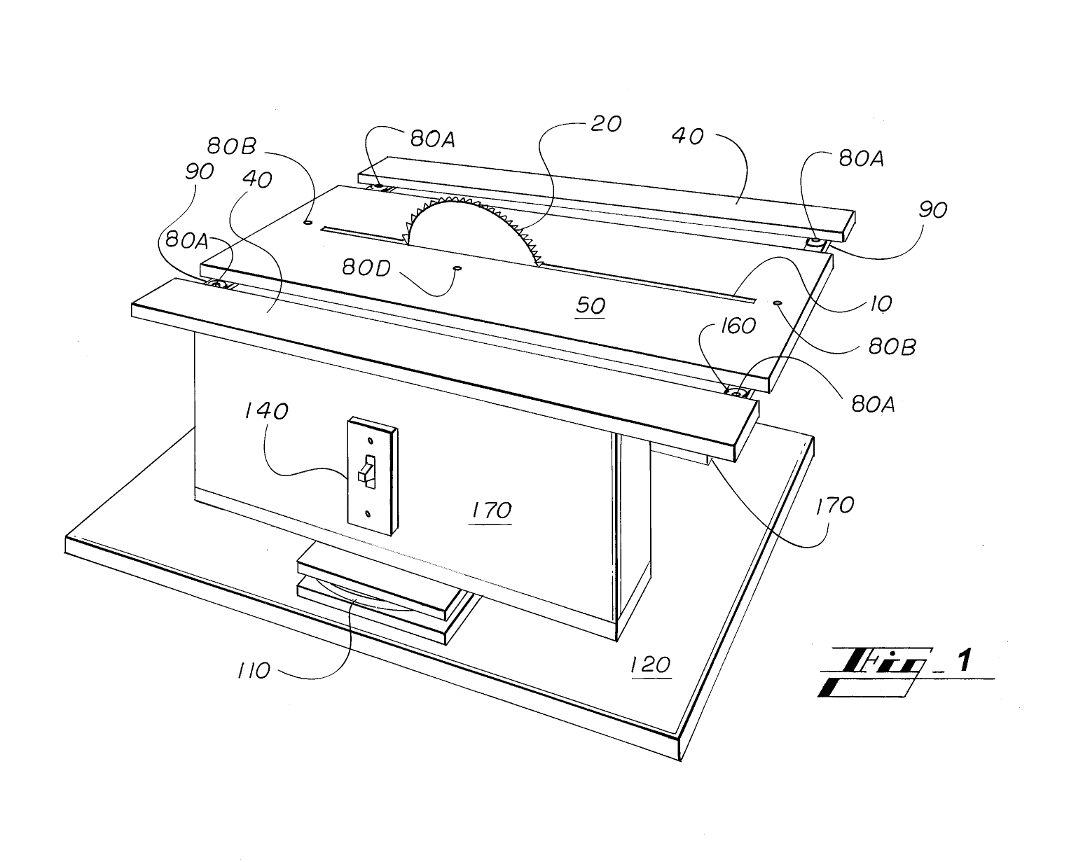

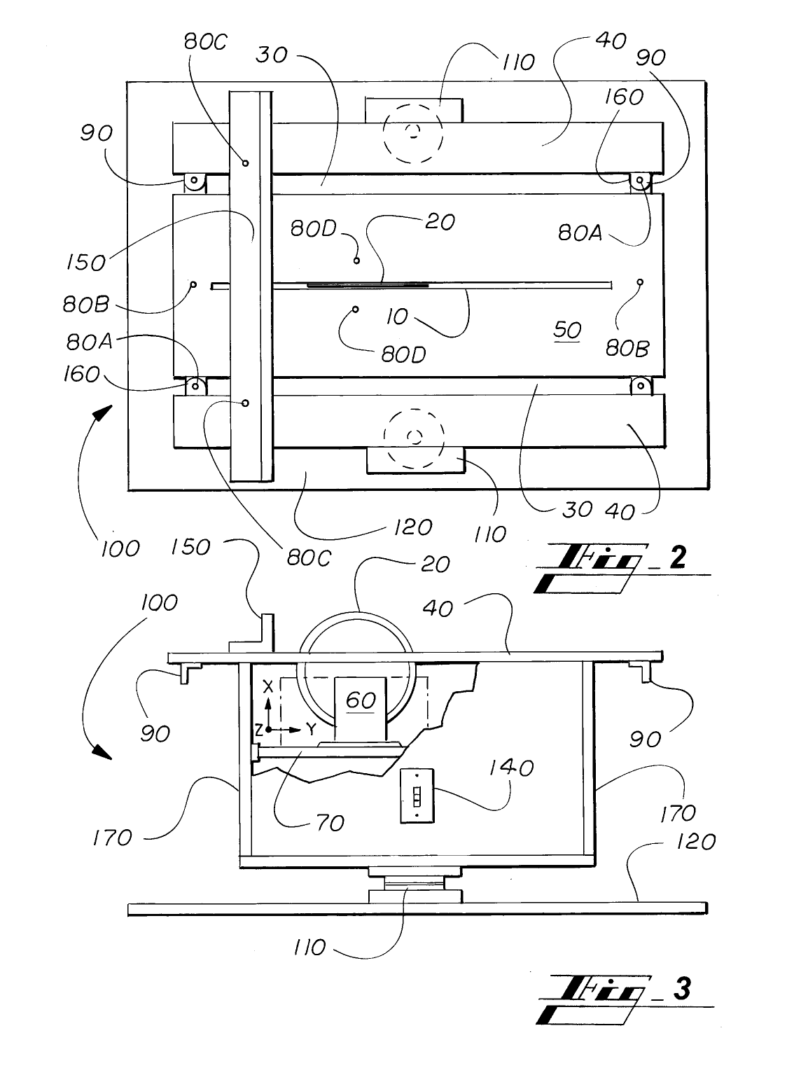

Referring now to FIG. 1, a saw table 100, in its standard position, is depicted that is able to cut various work-pieces at ninety-degree angles. The standard position is formed when the center tabletop section 50 and side tabletop sections 40 are parallel with the base 120 or the blade channel 10 intersects the fence 150 at a ninety degree angle as shown in FIG. 2. Work-pieces may include, but are not limited to: small lumber strips, large lumber sheets, plywood, 2×4's, etc. The blade channel 10 allows the blade 20 to protrude through the center tabletop section 50 of the saw table 100. As the blade 20 during use, the blade channel 10 also assists in preventing the blade 20 from being mis-aligned with the work-piece.

FIG. 2 depicts the saw table 100 from a perspective view in its standard position and represents one embodiment comprising brackets 160 which are attached to the underside of each end of the side tabletop sections 40. The brackets 160 extend inwardly, in relation to the saw table 100, beyond the width of each side tabletop section 40 to allow for drop pins 80a to be inserted through the brackets 160 into the rails 90 at each respective end.

Drop pins 80(a, b, c, d) may be any hardware which facilitates pivoting, or other conversions, of the components of the saw table 100 such as, but not limited to: dowels, bolts, pegs, etc. Drop pins 80(a, b, c, d) also assist in the easy set-up and breakdown of the saw table 100 as opposed the use of nails or other hardware which is useful for more permanent fixtures. There are several areas of the saw table 100 which utilize drop pins 80(a, b, c, d) to facilitate position changes of components of the saw table 100. For instance, side tabletop sections 40 may utilize drop pins 80a, center tabletop section 50 may utilize drop pins 80b, the fence 150 may utilize drop pins 80c, and the blade guard 60 may utilize drop pins 80d.

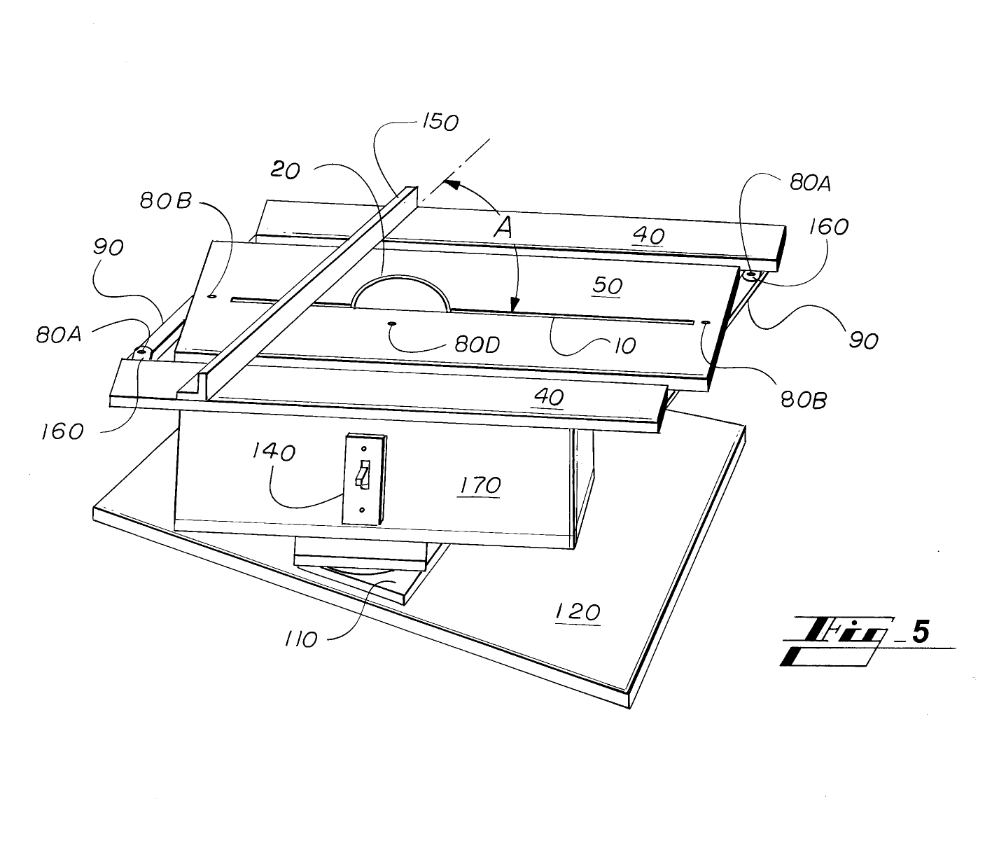

The aforementioned embodiment allows for optimal positional value, via the use of brackets 160, once the saw table 100 is pivoted into the parallelogram position. Optimal positional value comprises the decrease of gaps 30 until they are near, or close to, non-existent; and it comprises the center tabletop section 50 and side tabletop sections 40 being as close as possible to each other during parallelogram position as shown in FIG. 4.

In an alternate embodiment, the rails 90 are directly attached to the underside of the side tabletop sections 40 via drop pins 80a. However, the side tabletop sections 40 should be connected to the rails 90 near their innermost area, relative to center tabletop section 50, of the side tabletop sections 40 to allow for optimal positional value once pivoted into the parallelogram position.

The center tabletop section 50 is attached to the rails 90 at their centers by drop pins 80b. The drop pins 80b allow the center table section 50 to pivot in relation to the side tabletop sections 40. Pivoting of the saw table 100 is facilitated via the one or multiple rotators 110 which are attached to the base 120. The rotators 110 may be any suitable device, which would attach to the base 120 and allow the frame 130 to pivot to and from a parallelogram shape. Any rotator 110 device such as those used to secure and rotate boat seats, may be used to facilitate pivoting of the frame 130 in relation to the base 120. The frame comprises the side tabletop sections 40, side tabletop stands 170, center tabletop section 50, and the rails 90. As the saw table 100 is pivoted using the rotators 110, the rails 90 ensure that the center tabletop section 50 and the side table sections 40 remain aligned to guarantee accuracy and precision cutting.

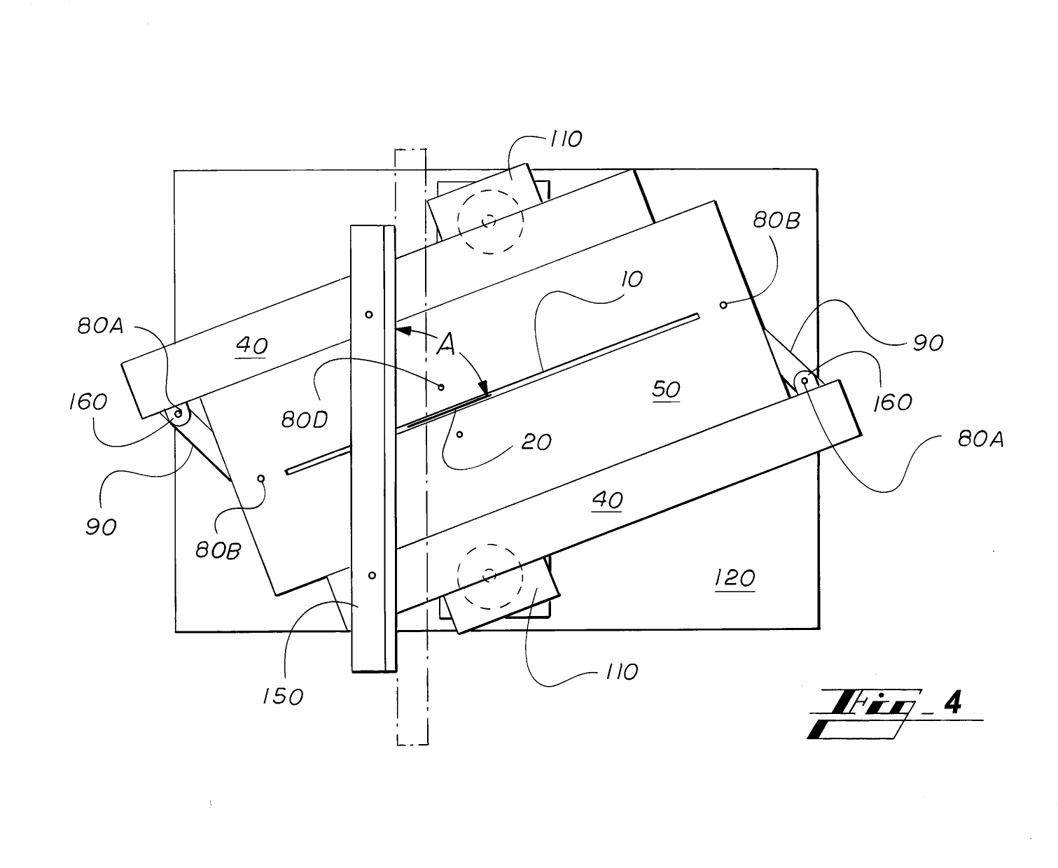

FIG. 3 depicts a cut-away view of the blade guard 60, which serves several different functions as it houses the blade 20. The power source needed to rotate the blade 20 may be attached to the blade guard 60 or the frame 130 and operated by the switch 140. The switch 140 may be any means for sending or cutting power to the blade 20. In one embodiment, the blade guard 60 may be locked in place and secured by drop pins 80d so that the blade guard 60 becomes stationary. Once the blade guard 60 is stationary, the blade 20 will still rotate, when power is sent, about a fixed point within the blade channel 10. Conversely, to facilitate longitudinal movement of the blade 20 along the length of the center tabletop section 50 during use, the drop pins 80d may be removed allowing the blade guard 60 to run on a track 70 which is located under the center tabletop section 50, Various components may be used for the track 70, including but not limited to: ball bearings, slotted and fitted structures, etc. When the drop pins 80d are removed and the blade guard 60 is mobile, the track 70 allows the user to run the blade guard 60 along the length of the channel 10 to make a one-pass cut of any work-piece. The blade guard 60 may also include a means for adjusting the blade 20 diagonally or along a vertical or horizontal axis within the blade guard 60. Adjusting the blade 20 on the vertical or horizontal axis has several benefits including maintaining a more precise and accurate cut and regulating the depth of a cut on any work-piece.

The side tabletop sections 40 are separated from the center tabletop section 50 by gaps 30. As the saw table 100 is pivoted into to its parallelogram position, as shown in FIG. 4, the gaps' 30 width decreases as the distance between the center tabletop section 50 and the side tabletop sections 40 decrease. The parallelogram formation of the saw table 100 may be formed to the right or the left of the y-axis relative In he position of the user. The benefit of the parallelogram formation of the saw table 100 is that it allows the cutting angle of the blade 20 to change relative to the fence 150 and work-piece. As a user is pivoting the saw table from its standard position to the parallelogram position, the angle A formed between the blade 20 and the fence 150 is either increased or decreased relative to the user. To increase the ease of motion of the saw table 100 as a whole, side tabletop sections 40 provide additional support from the base 120, via stands 170, of the tool by facilitating the pivot of the saw table 100.

FIG. 4 further depicts the saw table 100 utilizing the fence 150. The fence 150 is used to align work-pieces at specific angles in relation to the blade. The fence 150 connects to each of the side table sections 40 via drop pins 80c, which allow the angle of the fence to change relative to the blade channel 10 but stay the same relative to the base 120. The location of the fence 150 drop pins 80c are key to maintaining the alignment of the fence 150 relative to the base 120. The fence 150 drop pins 80c should be as close as possible to the front of the fence 150 and align with the inner area of the corresponding side table sections 40. This embodiment allows the fence 150 to pivot smoothly without the need for un-pinning and re-pinning the fence 150, utilizing drop pins 80c, each time a position change is required.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A saw table comprising a center tabletop section and a plurality of side tabletop sections each aligned together via a plurality of rails at each end; a plurality of side tabletop stands connected to each side tabletop section and at least one rotator; where the rotator is attached to a base, wherein pivoting of the side tabletop sections from a standard position configures the saw table in the form of a parallelogram.

2. The saw table of claim 1 comprising a saw mounted on a blade guard attached to a track in a manner to allow longitudinal movement of the blade guard on the track.

3. The saw table of claim 2 wherein the track is attached to the underside of the tabletop.

4. The saw table of claim 2 wherein the blade guard is locked in place with drop pins.

5. The saw table of claim 1 wherein a fence is variably positionable on the tabletop by drop pins.

6. The saw table of claim 1 wherein brackets connect the side tabletop sections to the rails to facilitate to facilitate alignment during position change.

7. A method for using a saw table comprising pivoting the saw table about at least one rotator where the at least one rotator is attached to a base and the pivoting results in a parallelogram formation of the saw table.

8. A method for using the saw table of claim 7 wherein removing drop pins from the blade guard allows for longitudinal movement of the blade guard.

9. A method for using the saw table of claim 8 wherein longitudinal movement of the blade guard cuts a work-piece.

10. A method for using the saw table of claim 7 wherein adjusting the blade guard adjusts the blade height relative to the blade channel.

11. A method for using the saw table of claim 7 wherein adjusting the blade guard adjusts the blade orientation relative to the blade channel.

12. A method for using the saw table of claim 7 wherein removing drop pins allows the fence to be re-positioned.
